(19) United States
(12) Patent Application Publication
(10) Pub. No.: US 2013/0159143 A1
(43) Pub. Date: Jun. 20, 2013

(54) METHOD, SYSTEM AND SOFTWARE PRODUCT FOR SELECTING TOILET REPAIR PRODUCTS

(71) Applicant: Lavelle Industries, INC., Burlington, WI (US)

(72) Inventors: Robert Cheney, Delavan, WI (US); Anne Reesman, Burlington, WI (US); Paul Rubach, Milwaukee, WI (US)

(73) Assignee: LAVELLE INDUSTRIES, INC., Burlington, WI (US)

(21) Appl. No.: 13/687,085

(22) Filed: Nov. 28, 2012

Related U.S. Application Data
(60) Provisional application No. 61/564,058, filed on Nov. 28, 2011.

(51) Int. Cl. G06Q 30/06

(52) U.S. Cl. CPC G06Q 30/0627; G06Q 30/0643
USPC 705/26.63

(57) ABSTRACT

A method, system and software product provides a comprehensive toilet repair product selector guide. A search engine is made available to consumers, retail sellers and others in an “on-line” format. Such a method, system and software product will provide the user with prompts and guidance for diagnosing toilet problems, improving toilet performance and realizing water savings. The method, system and software product of the present invention would be accessible using mobile encoding technology, personal digital assistants (such as “smart phones” and the like) and other personal computing devices.

This Application claims the benefit of U.S. Provisional Application No. 61/564,058, filed Nov. 28, 2011.

### FIELD OF THE INVENTION

This invention relates generally to the marketing and selling of products and services. It also relates generally to web-based (i.e. utilized by means of the virtual community that exists within the “world wide web,” or “www”) methods and systems for electronically acquiring, storing, processing, retrieving and displaying information and data. More specifically, the present invention relates to a method, system and software product that provides an electronic search engine that allows users and consumers of toilet repair products to search for and select suitable products for particular toilet repair or replacement applications. It also relates to a user-friendly and computerized system platform for diagnosing toilet problems, improving toilet performance and realizing water savings.

### BACKGROUND OF THE INVENTION

A wide variety of toilet repair products are sold in the aftermarket. This includes, but is not limited to, toilet tank fill valves, toilet tank flush valves and toilet tank flappers, among other things. Selection of the proper repair or replacement parts typically requires the retail seller of such parts, or the consumer, to reference a wide range of available product data information. Some of that information may reside on the shelves of the retail seller, may be contained in product brochures or catalogs, or may be listed on a website that must be properly navigated by the user to get to the proper replacement part or parts. In the experience of these inventors, this can be a labor-intensive process.

In this age of electronic data processing and communications, the internet provides consumers and sellers with promotional opportunities and benefits not previously made possible. This is particularly true for sellers who, up to now, have sold products and services only through catalogs. As in other retail sales areas, it is recognized by these inventors that consumers and retail sellers of toilet repair products are becoming more and more intrigued with the potential use of technology to aid in the search for compatible or suitable replacement toilet repair products. In the view of these inventors, what is needed is a method, system and software product for selecting toilet repair products that expands the use of technology and replaces the more labor-intensive process now used. Indeed, electronic data processing and communications make the method and system of the present invention possible. The present invention is also made possible by the use of specialized software that will allow consumers and retail sellers to access and utilize a comprehensive toilet repair product selector guide and search engine. It will provide the user with a convenient and easy to use electronic platform for diagnosing toilet problems, improving toilet performance and realizing water savings. The present invention will also specifically allow the method and system to be used with other electronic technologies, including, but not limited to, two-dimensional or matrix bar codes, such as the “Quick Response” code (or “QR code”), the Aztec code, the Microsoft® tag and other similar matrix bar codes. This aspect of the present invention would provide the user with mobile capabilities for product selection and performance assessments.

### SUMMARY OF THE INVENTION

In accordance with the foregoing, these inventors have perceived a need to provide such a method, system and software product where a comprehensive toilet repair product selector guide or search engine is made available to consumers, retail sellers and others in an “on-line” format. Such a method, system and software product will provide the user with prompts and guidance for diagnosing toilet product problems, improving toilet performance and realizing water savings. These inventors further envision that the method, system and software product of the present invention would be accessible using mobile encoding technology, personal digital assistants and personal computing devices.

The foregoing and other features of the method, system and software product of the present invention will become apparent from the detailed description that follows.

### BRIEF DESCRIPTION OF THE DRAWINGS

FIG. 1 is a flowchart showing a processing procedure and electronic search engine that is configured in accordance with the present invention.

FIGS. 2A and 2B are portions of a diagnostic diagram that is configured in accordance with the present invention.

FIGS. 3A through 3C illustrate exemplary screen displays on an electronic device that is capable of processing mobile applications.

### DETAILED DESCRIPTION

As a prefatory statement, it is to be understood that the method and system of the present invention assumes usage of a specific computer program product that is used within an electronic commerce (or “e-commerce”) environment and that comprises certain system building block “components.” Those components are data structures, data processors and interfaces, and each component is a functional element. The data structures are places to organize and store data. The data processors are used to manipulate data by performing processes or applying algorithms to the data. The interfaces connect the data structures and the data processors to the outside world, or to other data structures and data processors, including the virtual community that exists within the “world wide web” or “www.” The program includes source code which is a list of instructions, written in a selected computer language, and then converted into computer machine language, which language the computer uses to build the software “machine” described by the instructions. The software machine is made up of the components referred to above. The source code is a detailed “blueprint” telling the computer how to assemble those components into the software machine. Further, the source code is organized into separate files, files are organized into separate modules, and modules are organized into separate functions or routines to accomplish, via pre-programmed algorithms, the necessary steps in accordance with the method and system of the present invention. It is to be understood that the specific way that the source code is organized into files, modules and functions is a matter of programmer design choice and is not a limitation of the present invention.

It should also be understood that the method and system of the present invention is made possible by virtue of the existence of the Internet. The internet offers opportunities and benefits that cannot be performed with the use of printed product catalogs or other promotional literature. The “product selection” software program, method and system that is the subject of the present invention will enable users to properly determine the correct replacement product to be used in a given application. The program, method and system queue the user and direct the user's inquiries in accordance with a pre-programmed scheme. Further, the method, system and software product of the present invention are accessible using mobile encoding technology, personal digital assistants (such as “smart phones” and the like) and other personal computing devices, preferably with touch screen technology although such is not a limitation of the present invention.

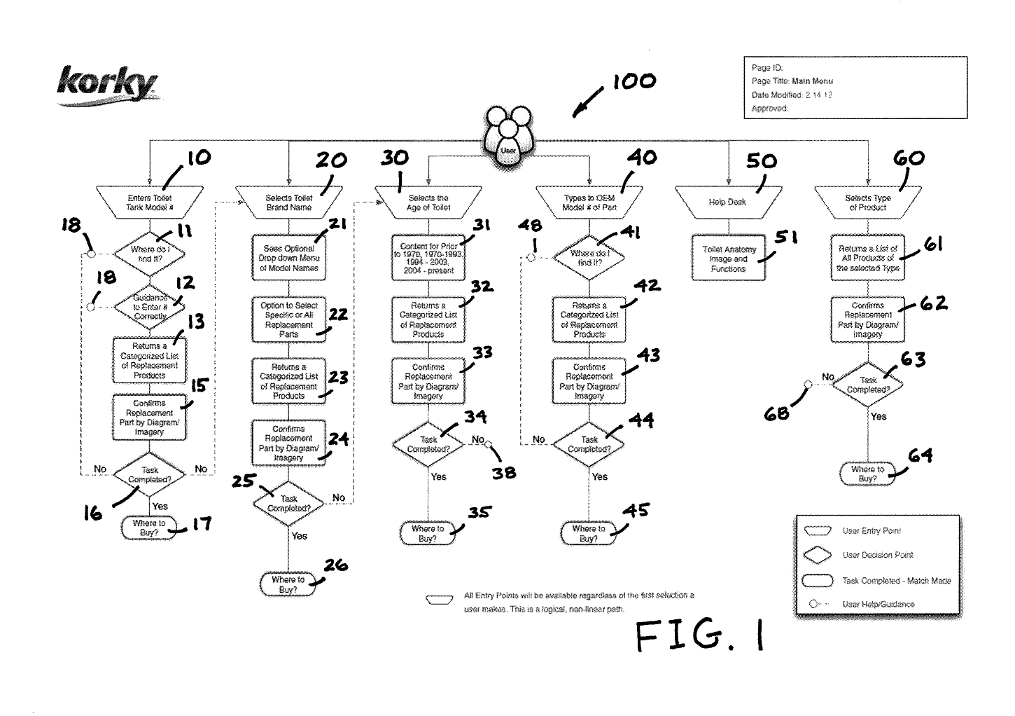

Referring now to the detailed drawings, wherein like numbered elements represent like elements throughout, FIG. 1 shows a graphic representation of the flow of information provided to the user in accordance with the product selection software program of the present invention. The overall system (100) provides the user with six starting points relative to product inquiry, which is a first tier of user inquiry in accordance with the present invention. Specifically, and as a first starting point, the user can elect to enter the user's toilet product model number (10) for the toilet product in question. Alternatively, and as a second starting point in this tier, the user can select the brand name of the toilet product (20) that is to be repaired. Alternatively, and as other starting points, the user can select the age of the toilet product (30) or the OEM model number of the toilet repair product in question (40). The user can also access a “Help Desk” function (50) for the purpose of familiarizing the user with toilet anatomy and nomenclature. Lastly, the user can simply select the specific type of toilet product (60) that the user is attempting to repair or replace a part for. Other starting points could be included within this tier and the present invention is not limited to the starting points identified herein.

In the search mode where the user enters the model number of the toilet product tank (10), the user will be asked where he or she can physically find the model number (11) and/or be given guidance to enter the model number correctly (12). The next step in the process is what these inventors will refer to herein as a “smart search.” That is, a list of all toilet product models with the numbers populating as the user continues to type the model number or choose it from a returned list of repair or replacement products (13) for the toilet model, and visually confirm the repair or replacement part selected by a visual diagram or imagery (15). This “smart search” concept is used with other aspects of the method of the present invention and will be refereed to elsewhere in this detailed description. In regards to this particular search method, it is important that the numbers self-populate in the event the stamp of the toile product model number isn't fully legible or is otherwise difficult to read. At the end of this portion of the flow chart (100), the user has either completed the task or has not (16). It should be noted here that the program does not specifically “ask” or prompt the user to determine if the user has actually completed the task. If the user chooses to go back to the main menu, however, the user can do that and has the option of again selecting an option (10, 20, 30, 40, 50, 60) from that main menu. If the task is completed, the user will be directed to locations where the toilet repair product can be purchased (17), including brick and mortar stores, e-commerce stores or other commercial outlets. If the task is not completed, the user may need to return to the first tier of searching in the toilet product model number entry point (10) or will be asked to select a toilet brand name (20). Further, user help or guidance (18) may be provided to the user to assist the user and direct the user's search.

Whether a user selects the toilet product brand name (20) directly or is redirected to that point by the prior search, the user will see an optional “drop down” menu of toilet product model names (21). The user will be given the option to select specific or all toilet repair products or toilet replacement parts (22). A categorized list of toilet repair or replacement products is returned to the database (23) and the toilet repair or replacement part or products are confirmed by diagram and/or imagery (24). At this point, the user has either completed the task or has not (25). Again, the program does not specifically ask the user to determine if she or he has actually completed the task. Assuming that the user has completed the task, the user will then be directed to locations where he or she can purchase the toilet repair products (26). Alternatively, the user will be directed to the search category where the user selects the age of the toilet product (30).

Whether the user selects the age of the toilet product (30) directly or is redirected from the toilet brand name logic search task (20), the user will see conditional content for various production period dates for toilet products, such as (i) prior to 1975, (ii) 1975 to 1990, (iii) 1990 to the present, (iv) 1997 to the present and (v) 2004 to the present (31). A categorized list of replacement products will be returned to the user (32) and the toilet repair or replacement products will be confirmed by diagram or imagery presented to the user (33). If the task is completed (34), the user will be directed where he or she can purchase the toilet repair product (35) or will be unable to purchase the toilet repair product because it is not available. If the task is not completed (34), the user will be provided with help and guidance information (38) or may return to the main menu, which is always an option for the user.

Where the user searches the types of toilet repair products that are in an OEM model number of the toilet repair product (40), the user will be asked where the model number can be found on the toilet repair product (41). This search will also be guided by use of the “smart search” functionality, as previously described. Help and guidance (48) can be made available to the user at this point as well. If identified properly, a categorized list of toilet repair or replacement products will be returned to the user (42) and the replacement part selection will be confirmed by diagram and/or imagery (43). If the task is completed (44), the user will be directed to where the toilet repair product can be purchased (45) or be redirected to where the OEM model number of the toilet repair product can be found (41). Here again, the user is not actually prompted as to whether the task is completed or not, such simply being the functionality of the method of the present invention.

As previously alluded to, a “Help Desk” function (50) is also provided in accordance with the present invention. By accessing this function, the user can familiarize herself or himself with toilet anatomy, terminology and industry nomenclature (51) which will aid in any searching that the user might want to conduct.

Where the user selects the type of toilet repair product directly (60), the program will return a list of all toilet repair products of the selected type to the user (61) and the selection will be confirmed by diagram and/or imagery of the toilet repair or replacement product (62). If the task is completed (63) (the user not actually being prompted as to whether the task is completed or not), the user will be directed to where the toilet repair product can be purchased (64). If the task is not completed, the user will be provided with help or guidance (68).

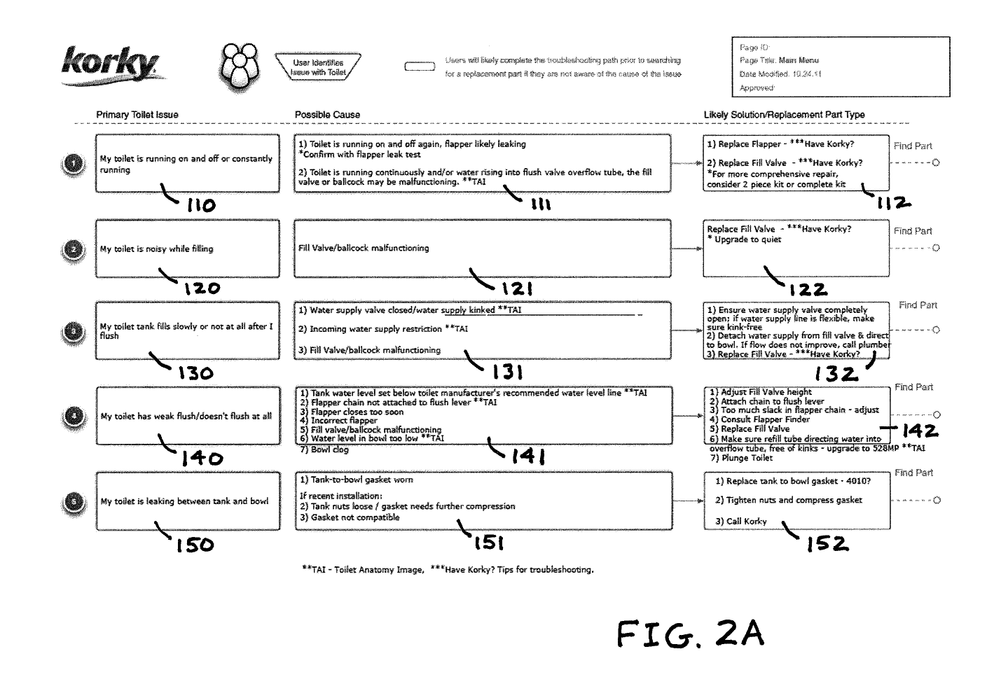

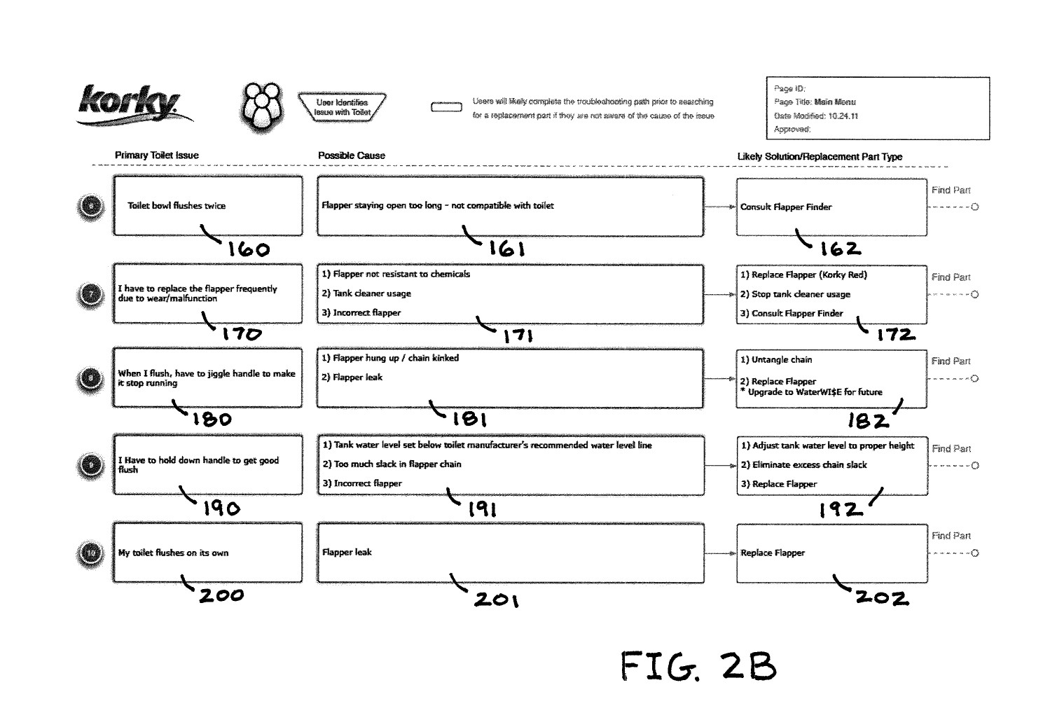

Referring now to FIGS. 2A and 2B, they illustrate a plurality of “primary” toilet problems that can be presented electronically to a user, the user being in search of a solution to one of many common issues. In the description that follows it is to be understood that other issues may be included and that the present invention is not limited to the issues presented herein.

Specifically, the options made available to the user electronically and in accordance with the present invention are the following:

(a) that the toilet is running on and off or is constantly running (110);

(b) that the user's toilet is noisy while filling (120);

(c) that the user's toilet tank fills slowly or not at all after flushing (130);

(d) that the user's toilet has a weak flush and/or doesn't flush at all (140);

(e) that the user's toilet is leaking between the tank and the bowl (150);

(f) that the toilet bowl flushes twice (160);

(g) that the user has to replace the flapper frequently due to wear and/or malfunction (170);

(h) that, when the user flushes the toilet, the user has to “jiggle” the handle to make it stop running (180);

(i) that the user must hold the handle down to get a good flush (190); and

(j) that the toilet flushes on its own (200).

In the situation where the toilet is running on and off or is constantly running (110), a list of possible causes is identified (111). Specifically, where the toilet is running on and off, a possible cause could be that the flapper is likely leaking. Where the toilet is running continuously and/or water is rising into the flush valve overflow tube, the fill valve or ballcock may be malfunctioning. At this point, a toilet “anatomy image” or visual queue will present itself to the user so that the user understands this particular problem and its cause. A list of likely solutions or replacement part types is then provided (112). With this issue (110) the flapper is replaced or the fill valve is replaced. At this point, the user will be directed to find the part in accordance with the search engine and logic diagram shown in FIG. 1. Additionally, the user may be asked to consider a more comprehensive repair which would be to consider a two piece kit or a complete kit of the replacement parts for this particular toilet issue.

In the situation where the toilet is noisy while filling (120), a possible cause might be that the fill valve or the ballcock is malfunctioning (121). This would require that the solution is to replace the fill valve (122) and a suggestion for upgrade would be made to the user as well. The user will also be presented with tips for trouble shooting and will be directed to find the part to solve the problem.

In the case of the toilet tank filling slowly or not at all after the user flushes (130), the possible causes might be that the water supply valve is closed and/or the water supply is kinked (131). At this point, a toilet anatomy image may be provided for the user's understanding of the particular problem cause. Alternatively, the cause might be that there is a restriction in the incoming water supply and, again, a toilet anatomy image may be presented to the user. A third possible cause would be that the fill valve and/or the ballcock are malfunctioning. In this situation, the likely solutions presented (132) include insuring that the water supply valve is completely open and, if the water supply line is flexible, to make sure that the line is not kinked. Other solutions include detaching the water supply from the fill valve and directly to the bowl. If this flow does not improve, it is recommended that the user call a plumber. Lastly, a likely solution is to replace the fill valve, in which case the user would be directed back to the search engine presented previously in accordance with FIG. 1.

In the situation where the toilet has a weak flush or does not flush at all (140), the possible causes (141) include that the water level in the tank is set below the toilet manufacturer's recommended level line. At this point, a toilet anatomy image could be presented to the user. Alternatively, another possible cause could be that the flapper chain is not attached to the flush lever. Again, a toilet anatomy image could be presented to the user. Other possible causes include that the flapper is closing too soon, that the flapper is incorrectly matched with the toilet, that the fill valve and/or the ballcock is malfunctioning, and that the water level in the toilet bowl is too low. Again, a toilet anatomy image could be presented to the user relative to the water level problem. Lastly, another possible cause could be that the toilet bowl is clogged. After assessing possible causes for the problem in question, a series of likely solutions is presented to the user (142). Those include adjustment of the fill valve height; attaching the chain to the flush lever; taking up the slack in the flapper chain; replace the fill valve; make sure that the refill tube directing water into the overflow tube is free of kinks; and that the toilet should be plunged. Another solution is that the user be prompted to consult the search engine shown in FIG. 1.

In the case where the toilet bowl is leaking between the tank and bowl (150), the list of possible causes (151) that is presented to the user includes that the tank to bowl gasket is worn and, if the toilet has been recently installed, that the tank nuts are loose and the gasket needs further compression or that the gasket is not compatible with this particular toilet. The likely solutions presented (152) include replacement of the tank to bowl gasket, tightening of the nuts to compress the gasket and using the logic diagram shown in FIG. 1 to resolve the problem.

In the situation where the toilet bowl flushes twice (160), a possible cause (161) is that the flapper is staying open too long and is not compatible with the toilet. Again, a likely solution (162) is presented, which is that the user consult the search engine illustrated in FIG. 1.

In the case where the user needs to replace the flapper frequently due to wear or malfunction (170), the list of possible solutions presented (171) includes that the flapper is not resisted to chemicals, that the use of tank cleaner is damaging the flapper or that the flapper is incorrectly fitted to the toilet. The list of likely solutions (172) would be to replace the flapper, to stop the use of toilet tank cleaning solution and to consult the search engine shown in FIG. 1.

In the situation where the toilet requires the handle to be “jiggled” after a flush and to make the water stop running, the list of possible causes for this issue (181) includes that the flapper is hung up, the chain is kinked or that the flapper leaks. The likely solutions presented (182) include untangling of the chain, replacing the flapper with a possible upgrade in that particular part or the overall assembly.

In the case where the user has to hold the handle down to achieve a suitable flush (190), the possible causes (191) for this issue could be that the tank water level is set below the toilet manufacturer's recommended water level line, that there is too much slack in the flapper chain or that the flapper is incorrectly chosen. The likely solutions (192) presented to the user include adjustment of the tank water level to the proper height, the elimination of the excess chain slack or replacement of the flapper. In this last regard, the user would again be directed to the search engine presented in accordance with the logic diagram shown in FIG. 1.

Lastly, in the case where the toilet flushes on its own (200), the possible cause (201) is that the flapper leaks and the likely solution (202) is that the flapper needs to be replaced. In order to do that, the user will again be prompted to consult the logic diagram shown in FIG. 1.

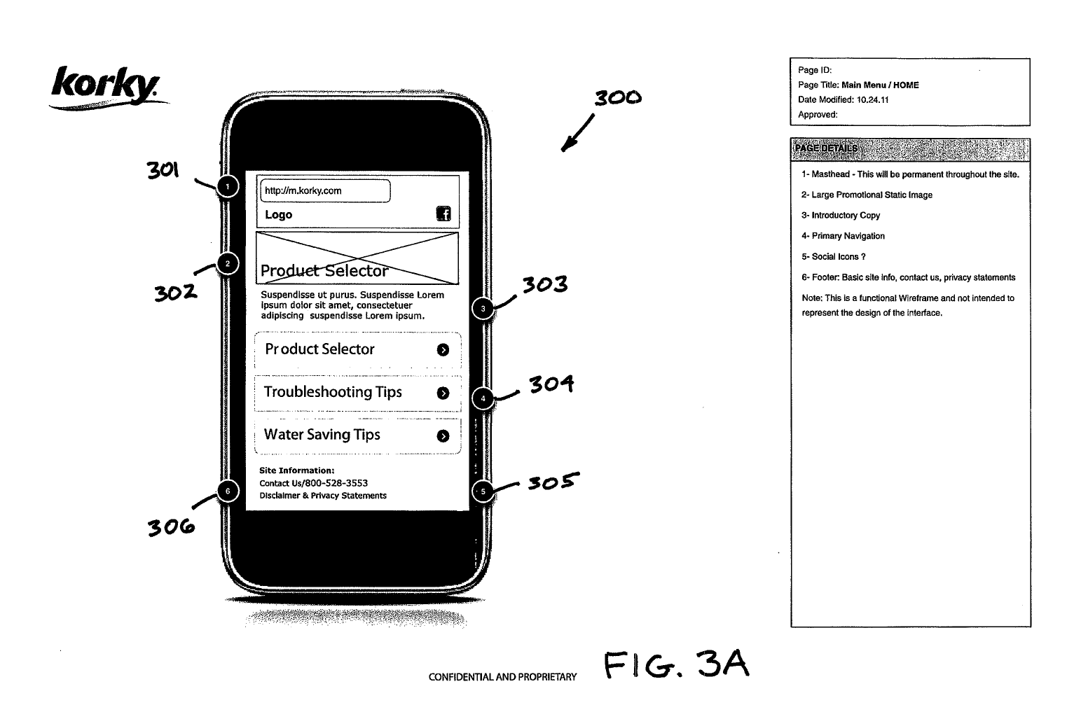

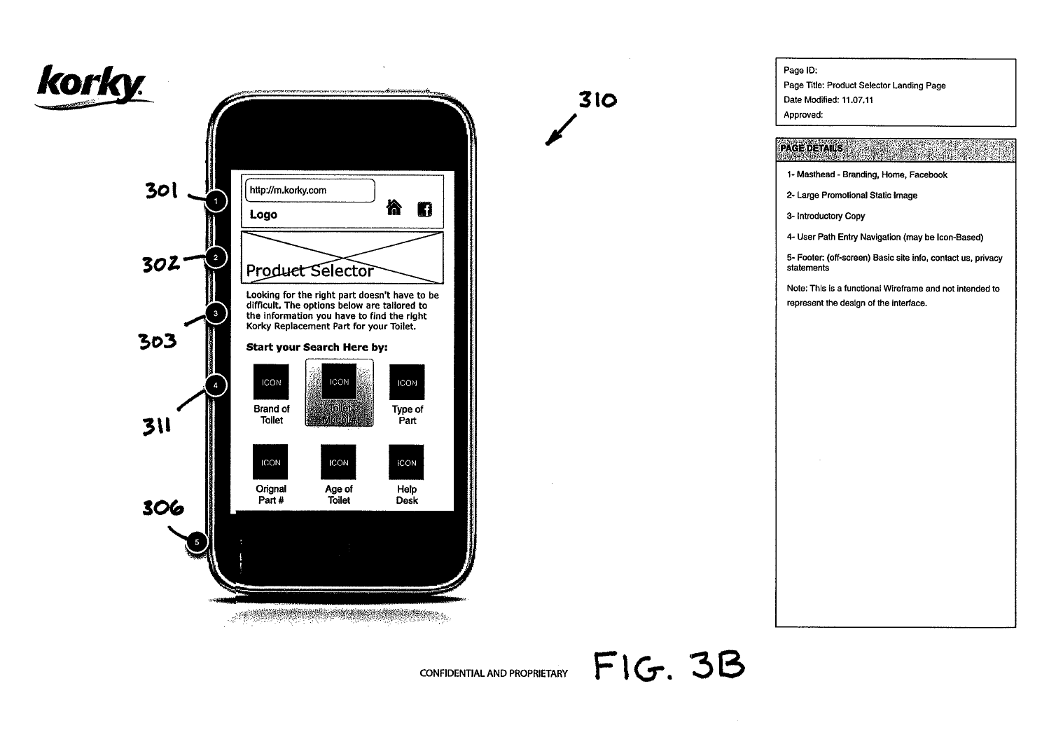

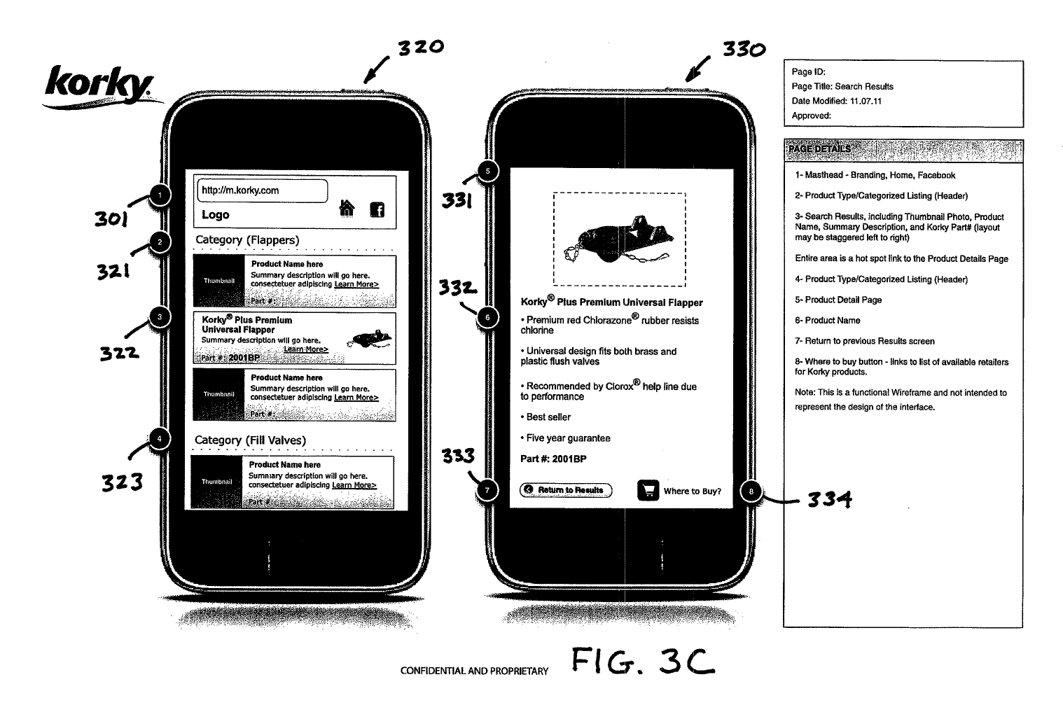

Referring now to FIGS. 3A through 3C, representative screen displays on a mobile electronic device are illustrated. In FIG. 3A, the display (300) generally includes a masthead (301) which is permanent throughout the user's access of the mobile application site. The display (300) could also include a large promotional static image (302), and introductory copy (303), options for primary navigation through the options presented to the user (304) as well as social icons (305) and a standard footer (306) which would include basic site information, privacy statements and the like.

Referring now specifically to the screen display (310) illustrated in FIG. 3B, it includes the masthead (301), the large promotional static image (302) and introductory copy (303). It also includes an icon-based user navigation entry path (311), which need not be icon-based, and the standard footer (306) mentioned above.

The first screen display (320) illustrated in FIG. 3C similarly includes the masthead (301) but also includes a product category headers (321, 323) and search results (322). The second screen display (330) shown in FIG. 3C illustrates a product detail page (331), the name of the product (332), a link to where the product can be purchased (334) and a return to previous results option (333).

In order to implement the customer or buyer interface of the software product of the present invention, it is to be understood that a number of alternative user interface suggestions can be made. For example, other screen displays can include suggestions or prompts as to how the search engine's functionality will be presented to users through a web page or windows form. These are intended as examples of how the user interface ties into the functionality of the search engine of the present invention and, when used with the method and system of the present invention, each presents a novel user interface.

In accordance with the foregoing, it will be seen that there has been provided a new and useful method, system and software product where a comprehensive toilet repair product selector guide or search engine is made available to consumers, retail sellers and others in an “on-line” format. This method, system and software product provides the user with prompts and guidance for diagnosing toilet problems, improving toilet performance and realizing water savings. The method, system and software product of the present invention is also accessible using mobile encoding technology and personal computing devices.

The details of the invention having been disclosed in accordance with the foregoing, we claim:

1. A computer implemented method to allow a user to select a toilet repair product for use with a toilet product, the method comprising the step of providing a user interface comprising user interface elements for allowing the user to select one or more of the following steps:
electronically entering the model number of the toilet product;
electronically selecting a brand name of the toilet product;
electronically selecting the age of the toilet product;
electronically selecting the OEM model number of the toilet repair product;
electronically accessing a help desk function; and
electronically selecting the toilet repair product for the toilet product by repair product type.

2. The method of claim 1 wherein the step of electronically entering a model number for the toilet product further comprises the steps of:
electronically prompting the user where to find the model number of the toilet product on the product;
electronically providing guidance to the user to electronically enter the model number correctly via a smart search;
electronically returning a categorized list of toilet repair products for the toilet product;
visually confirming the toilet repair product via electronically-generated visual imagery on the user interface; and
electronically providing the user with directions to locations where the toilet repair product can be purchased via brick and mortar retail stores, e-commerce retail stores or other retail commercial outlets.

3. The method of claim 1 wherein the step of electronically selecting the brand name of the toilet product further comprises the steps of:
electronically prompting the user where to find the brand name of the toilet product;
generating and displaying a list of brand names;
returning and displaying a list of toilet repair products for the toilet product;
visually confirming the toilet repair product via electronically-generated visual imagery on the user interface; and
electronically providing the user with directions to locations where the toilet repair product can be purchased via brick and mortar retail stores, e-commerce retail stores or other retail commercial outlets.

4. The method of claim 1 wherein the step of selecting the age of the toilet product further comprises the steps of:
generating and displaying a list of toilet product names by production period;
returning and displaying a list of toilet repair products for the toilet product;
visually confirming the toilet repair product part via electronically-generated visual imagery on the user interface; and
electronically providing the user with directions to locations where the toilet repair product can be purchased via brick and mortar retail stores, e-commerce retail stores or other retail commercial outlets.

5. The method of claim 1 wherein the step of electronically entering an OEM model number for the toilet repair product further comprises the steps of:
electronically prompting the user where to find the OEM model number of the toilet repair product on the toilet repair product;
electronically providing guidance to the user to electronically enter the model number correctly via a smart search;
electronically returning a categorized list of toilet repair products;
visually confirming the toilet repair product via electronically-generated visual imagery on the user interface; and
electronically providing the user with directions to locations where the toilet repair product can be purchased via brick and mortar retail stores, e-commerce retail stores or other retail commercial outlets.

6. The method of claim 1 wherein the step of selecting the toilet repair product by repair product type comprises the steps of:
electronically entering the type of the toilet repair product;
returning and displaying a list of toilet repair products by type;
visually confirming the toilet repair product via electronically-generated visual imagery on the user interface; and
electronically providing the user with directions to locations where the toilet repair product can be purchased via brick and mortar retail stores, e-commerce retail stores or other retail commercial outlets.

7. The method of claim 1 wherein the step of providing a user interface comprises using a personal computing device, the personal computing device including functionality for displaying a plurality of screen displays for the user.

8. A system for selecting toilet repair products comprising:
a controller;
at least one user interface, the interface comprising a screen display;
wherein the controller is programmed in accordance with the method of claim 1.

9. A computer program product for selecting a toilet repair product for use with a toilet product, the computer program product being used with a user interface and embodied in a non-transitory computer readable medium comprising computer instructions for:
electronically entering the model number of the toilet product;
electronically selecting a brand name of the toilet product;
electronically selecting the age of the toilet product;
electronically selecting the OEM model number of the toilet repair product;
electronically accessing a help desk function; and
electronically selecting the toilet repair product for the toilet product by repair product type.

10. The computer program product of claim 9 further comprising, for the computer instructions for electronically entering a model number for a toilet product, computer instructions for:
electronically prompting the user where to find the model number of the toilet product on the product;
electronically providing guidance to the user to electronically enter the model number correctly via a smart search;
electronically returning a categorized list of repair products;
visually confirming the toilet repair product via electronically-generated visual imagery on the user interface; and
electronically providing the user with directions to locations where the toilet repair product can be purchased via brick and mortar retail stores, e-commerce retail stores or other retail commercial outlets.

11. The computer program product of claim 9 further comprising, for the computer instructions for selecting a brand name of the toilet product, computer instructions for:
electronically prompting the user where to find the brand name of the toilet product;
generating and displaying a list of brand names;
returning and displaying a list of toilet repair products for the toilet product;
visually confirming the toilet repair product via electronically-generated visual imagery on the user interface; and
electronically providing the user with directions to locations where the toilet repair product can be purchased via brick and mortar retail stores, e-commerce retail stores or other retail commercial outlets.

12. The computer program product of claim 9 further comprising, for the computer instructions for electronically selecting the age of the toilet product, computer instructions for:
generating and displaying a list of toilet product names by production period;
returning and displaying a list of toilet repair products for the toilet product;
visually confirming the toilet repair product via electronically-generated visual imagery on the user interface; and
electronically providing the user with directions to locations where the toilet repair product can be purchased via brick and mortar retail stores, e-commerce retail stores or other retail commercial outlets.

13. The computer program product of claim 9 further comprising, for the computer instructions for electronically entering an OEM number for the toilet repair product, computer instructions for:
electronically prompting the user where to find the OEM model number of the toilet repair product on the toilet repair product;
electronically providing guidance to the user to electronically enter the model number correctly via a smart search;
electronically returning a categorized list of toilet repair products;
visually confirming the toilet repair product via electronically-generated visual imagery on the user interface; and
electronically providing the user with directions to locations where the toilet repair product can be purchased via brick and mortar retail stores, e-commerce retail stores or other retail commercial outlets.

14. The computer program product of claim 9 further comprising, for the computer instructions for selecting the toilet repair product by toilet repair product type, computer instructions for:
electronically entering the type of the toilet repair product;
returning and displaying a list of toilet repair products by type;
visually confirming the toilet repair product via electronically-generated visual imagery on the user interface; and
electronically providing the user with directions to locations where the toilet repair product can be purchased via brick and mortar retail stores, e-commerce retail stores or other retail commercial outlets.

15. The computer program product of claim 9 wherein the user interface comprises using a personal computing device, the personal computing device including functionality for displaying a plurality of screen displays for the user.

16. A computer implemented method to allow a user to select solutions for toilet problems, the method comprising the step of:
providing a user interface comprising user interface elements for allowing the user to select from a plurality of toilet problems;
displaying a list of possible causes for such problems; and
presenting a list of likely solutions or toilet replacement parts.

17. The method of claim 16 further comprising the step of providing visual images via the user interface to illustrate the problems and their solutions.

18. The method of claim 16 wherein the step of providing a user interface comprises using a personal computing device, the personal computing device including functionality for displaying a plurality of screen displays for the user.

19. A computer program product for allowing a user to select solutions for toilet problems, the computer program product being used with a user interface and embodied in a non-transitory computer readable medium comprising computer instructions for:
selecting from a plurality of toilet problems;
displaying a list of possible causes for such problems; and
presenting a list of likely solutions or toilet replacement parts.

20. The computer program product of claim 19 further comprising computer instructions for providing visual images via the user interface to illustrate the problems and their solutions.

21. The computer program product of claim 19 wherein the user interface comprises using a personal computing device, the personal computing device including functionality for displaying a plurality of screen displays for the user.
